(19) United States
(12) Patent Application Publication
(10) Pub. No.: US 2007/0023661 A1
(43) Pub. Date: Feb. 1, 2007

(54) Infrared camera system

(75) Inventors: Matthias Wagner, Cambridge, MA (US); Ming Wu, Arlington, MA (US); Nikolay Nemchuk, North Andover, MA (US); Julie Cook, Newburyport, MA (US); Richard DeVito, Saugus, MA (US); Robert Murano, Melrose, MA (US); Lawrence H. Domash, Conway, MA (US)

Correspondence Address: WILMER CUTLER PICKERING HALE AND DORR LLP, 60 STATE STREET, BOSTON, MA, 02109, US

(73) Assignee: RedShift Systems Corporation, Waltham, MA (US)

(21) Appl. No.: 11/523,420

(22) Filed: Sep. 19, 2006

Related U.S. Application Data
(63) Continuation of application No. 10/925,860, filed on Aug. 25, 2004, now abandoned.
(60) Provisional application No. 60/498,167, filed on Aug. 26, 2003.
(60) Provisional application No. 60/566,610, filed on Apr. 28, 2004.
(60) Provisional application No. 60/506,985, filed on Sep. 29, 2003.
(60) Provisional application No. 60/535,389, filed on Jan. 9, 2004.
(60) Provisional application No. 60/535,391, filed on Jan. 9, 2004.
(60) Provisional application No. 60/583,341, filed on Jun. 28, 2004.
(60) Provisional application No. 60/583,573, filed on Jun. 28, 2004.

(51) Int. Cl. G01J 5/00

(52) U.S. Cl. 250/338.1

(57) ABSTRACT

An IR camera system includes an array of thermally-tunable optical filter pixels, an NIR source and an NIR detector array. The IR camera system further includes IR optics for directing IR radiation from a scene to be imaged onto the array of thermally-tunable optical filter pixels and NIR optics for directing NIR light from the NIR source, to the filter pixels and to the NIR detector arrays. The NIR source directs NIR light onto the array of thermally-tunable optical filter pixels. The NIR detector array receives NIR light modified by the array of thermally-tunable optical filter pixels and produces an electrical signal corresponding to the NIR light the NIR detector array receives.

### CROSS-REFERENCE TO RELATED APPLICATIONS

This application claims benefit of the following Patent Applications:

U.S. Provisional Patent Application Ser. No. 60/498,167, filed Aug. 26, 2003;

U.S. Provisional Patent Application Ser. No. 60/566,610, filed Apr. 28, 2004;

U.S. Provisional Patent Application Ser. No. 60/506,985, filed Sep. 29, 2003;

U.S. Provisional Patent Application Ser. No. 60/535,389, filed Jan. 9, 2004;

U.S. Provisional Patent Application Ser. No. 60/535,391, filed Jan. 9, 2004;

U.S. Provisional Patent Application Ser. No. 60/583,573, filed Jun. 28, 2004; and

U.S. Provisional Patent Application Ser. No. 60/583,341, filed Jun. 28, 2004.

### TECHNICAL FIELD

This invention relates generally to thermal imagers.

### BACKGROUND

The market for infrared cameras is large, and growing quickly, driven by military, security, medical, construction and automotive markets. Of particular interest are the wavelengths between 7 and 15 micrometers, where atmospheric transmission is high and sunlight has a relatively small contribution, and objects at temperatures in normal environments (room temperature or body temperature) radiate. Several types of imaging systems are used to observe wavelengths beyond visible. These range from narrow bandgap semiconductor photodetector arrays, which typically require cryogenic cooling, to the more recent un-cooled microbolometer arrays. However, all of these “focal plane” technologies are expensive (for example, the lowest-priced cameras are just breaking the $10,000 barrier), making thermal imaging out of reach for the vast majority of the commercial and consumer markets. Moreover, all of the existing products use manufacturing techniques that are inherently low-yield, driving costs up, but also limiting the resolution (i.e., number of pixels) that is practical for all but the most cost-insensitive uses.

### SUMMARY OF THE INVENTION

In one aspect, a camera system for producing an image from light of a first wavelength from a scene includes an array of thermally-tunable optical filter pixel elements, a light source and a detector array. Each pixel element has a passband that shifts in wavelength, due to a refractive index change, as a temperature of the pixel element changes. The light source provides light of a second wavelength to the array of thermally-tunable optical filter pixel elements, such that the array of thermally-tunable optical pixel elements produces filtered light of the second wavelength. The light source may include an LED or a laser. The detector array, which may include a CCD or CMOS camera, receives the filtered light of the second wavelength from the array of thermally-tunable optical filter pixel elements and for produces an electrical signal corresponding to an image of the scene. The camera system further includes optics for directing light of the first wavelength from the scene onto the array of thermally-tunable optical filter pixel elements. The array of thermally-tunable optical filter pixel elements converts at least some of the light of the first wavelength to heat and absorbs at least some of the heat.

The light of the first wavelength can b, for example, IR light, and the light of the second wavelength can be, for example, NIR light.

The array of thermally-tunable optical filter pixel elements is sealed in an evacuated package that includes a window transparent to radiation, a substrate for supporting the array of thermally-tunable optical filter pixel elements, and a sealing frame for joining the window and the substrate together. The package may include a getter material disposed within for absorbing extraneous gasses. The pixel elements may include a material for absorbing light at first wavelength and generate heat into filter. Each pixel element of the array of thermally-tunable optical filter pixel elements is attached to the substrate by a hollow pixel post that thermally insulates the pixel element from the substrate. The post may also be solid.

The array of thermally-tunable optical filter pixel absorbs light at the first wavelength and converts the light at the first wavelength into heat.

Each pixel element of the array of thermally-tunable optical filter pixel elements includes an index tunable thin film interference coating, which forms a single-cavity or multiple-cavity Fabry-Perot structure. The array of thermally-tunable optical filter pixel elements includes a reflecting layer or an absorbing layer to mitigate light of the second wavelength that passes between the pixel elements.

The camera system may include a reference filter to narrow the bandwidth of the light of the second wavelength from the light source.

The camera system may operate in a transmissive mode, such that the light of the second wavelength passes through the array of thermally-tunable optical filter pixel elements and then propagates to the detector array. The camera system may operate in a reflective mode, such that the light of the second wavelength reflects off of the array of thermally-tunable optical filter pixel elements and then propagates to the detector array.

In another aspect, a method of generating an image based on light of a first wavelength from a scene includes generating light of a second wavelength, converting the light of the first wavelength to heat, and coupling the heat to a thermally-tunable optical filter array to vary the temperature of thermally-tunable optical filter array. Each element of the thermally-tunable optical filter array has a passband that shifts in wavelength, due to a refractive index change, as a temperature of the thermally-tunable optical filter element changes. The method further includes filtering the light of the second wavelength with the thermally-tunable optical filter array such that the thermally-tunable optical filter array produces filtered light of the second wavelength. The method also includes detecting the filtered light of the second wavelength with a detector array, so as to produce an signal corresponding an image of the scene.

In another aspect, an optically-read temperature sensor includes a thermally-tunable optical filter having a passband that shifts in wavelength, due to a refractive index change, as a temperature of the thermally-tunable optical filter changes. The sensor also includes a light source for providing light of a first wavelength to the thermally-tunable optical filter such that the thermally-tunable optical filter produces filtered light of the second wavelength. The sensor further includes a detector for receiving the filtered light of the second wavelength from the thermally-tunable optical filter, and for producing an electrical signal corresponding to the temperature of the thermally-tunable optical filter.

In another aspect, a method of sensing a temperature or a temperature profile includes generating light of a first wavelength, and filtering the light of the first wavelength with a thermally-tunable optical filter having a passband that shifts in wavelength, due to a refractive index change, as a temperature of the thermally-tunable optical filter changes, so as to produce filtered light of the first wavelength. The method further includes detecting the filtered light of the first wavelength with a detector and producing an electrical signal corresponding to the temperature of the thermally-tunable optical filter.

In another aspect, a method of fabricating a post for supporting a component above a substrate includes depositing a sacrificial layer onto the substrate, forming a substantially cylindrical hole in the sacrificial layer, and conformally depositing a protection layer onto the sacrificial layer. The protection layer coats a surface of the sacrificial layer, bottom of the hole and walls of the hole, and the protection layer forms a pinch-off at the top of the hole. The method further includes fabricating the component on the protection layer, vertically etching the filter and the protection layer at a peripheral boundary of the component, and laterally etching the sacrificial layer to the protection layer that forms the walls of the hole.

In another aspect, a wavelength conversion device includes a thermally-tunable optical filter having a passband that shifts in wavelength, due to a refractive index change, as a temperature of the thermally-tunable optical filter changes. The device further includes an absorber for converting radiation at a first wavelength into heat, and for coupling the heat to the thermally-tunable optical filter. The device also includes a light source for providing light at a second wavelength to the thermally-tunable optical filter, such that the thermally-tunable optical filter produces filtered light of the second wavelength. The device further includes a detector for receiving the light at the second wavelength from the thermally-tunable optical filter and for producing an electrical signal corresponding to the light at the second wavelength. The device also includes optics for directing the radiation at the first wavelength onto the thermally-tunable optical filter. The thermally-tunable optical filter converts at least some of the light of the first wavelength to heat and absorbs at least some of the heat.

In another aspect, a method of sensing a temperature includes generating light of a first wavelength, filtering the light of the first wavelength with a thermally-tunable optical filter having a passband that shifts in wavelength, due to a refractive index change, as a temperature of the thermally-tunable optical filter changes, so as to produce filtered light of the first wavelength. The method further includes detecting the filtered light of the first wavelength with a detector and producing an electrical signal corresponding to the temperature of the thermally-tunable optical filter.

### BRIEF DESCRIPTION OF THE DRAWINGS

FIG. 1 shows the described embodiment of an IR camera system.

FIGS. 2a and 2b illustrates the filtering characteristics of an individual pixel element with respect to temperature.

FIGS. 3a and 3b shows the filtering characteristics of FIGS. 2a and 2b with a narrowband source.

FIG. 4a shows a cross section of an FPA.

FIG. 4b shows a reflecting layer below the trenches between pixel elements.

FIG. 5 shows a top view of a portion of the array of pixel elements.

FIGS. 6a through 6h illustrate the process for fabricating the pixel posts.

FIGS. 7a through 7r illustrate other fabrication techniques for the pixel posts.

FIG. 8a shows a wafer with prefabricated pixel arrays.

FIG. 8b shows components used for vacuum packaging of an FPA.

FIG. 8c shows the components of FIG. 8b being assembled.

FIG. 9 illustrates an IR camera system used in reflective mode.

FIG. 10 shows an IR camera system with an NIR source embedded in the IR lens.

FIG. 11 shows an IR camera system with an NIR source embedded in the NIR lens.

FIG. 12 shows a grating layer on the FPA redirecting NIR light from an offset LED.

FIG. 13 shows a remote-readout thermometer.

The figures shown herein are merely illustrative and are not drawn to scale.

### DETAILED DESCRIPTION

The described embodiment is an uncooled, infrared (IR) camera system that uses thermally-tunable optical filter elements that respond to IR energy (e.g., light with wavelength typically ranging from 8 to 15 μm, although other wavelengths may be considered IR—also referred to herein as IR light and IR radiation) radiated by a scene to be imaged. The filter elements modulate a near-IR (NIR) carrier signal (e.g., light with a wavelength of approximately 850 nm—also referred to as NIR optical signal, NIR light, probe, probe signal or probe light) as a result of changes in the IR energy. The camera system detects the modulated carrier signal with a NIR detector (e.g., a CMOS or CCD based imaging array, or a p-i-n photo diode array).

The IR camera system is based on a thermal sensor that uses optical readout. The underlying principle of this thermal sensor described herein is simple. A narrowband source generates an “optical carrier signal” with a specific wavelength spectrum. A thermally-tunable optical filter is used at the sensor location where local changes in temperature cause the filter to shift its filtering spectrum. The local changes in temperature may be due to ambient environmental temperature, or they may be due to radiation from an external source. The thermally-tunable optical filter processes the optical carrier such that the resulting light is the “product” of the carrier signal and the sensor filter. An optical detector measures the total power of this resulting light, and the detector is sensitive enough to detect and measure small changes in the total power.

One of the key elements of this thermal sensor is a multilayer optical interference filter that is highly tunable with temperature. The filter incorporates semiconductor materials with a refractive index that depends strongly on temperature to create a solid-state, tunable thin film optical filter (see, for example, U.S. Ser. No. 10/005,174, filed Dec. 4, 2001 and entitled “TUNABLE OPTICAL FILTER;” and U.S. Ser. No. 10/174,503, filed Jun. 17, 2002, entitled “INDEX TUNABLE THIN FILM INTERFERENCE COATINGS” both of which are incorporated herein by reference. A number of other materials that can be used as the thermo-optic layers in these thin film filter structures, including germanium (if the probe wavelength is long), a number of polymers (e.g., polyimide), Fe₂O₃, liquid crystals, etc. These materials are associated with different operating ranges in terms of probe signal wavelength, possibly including visible wavelengths.

This multilayer temperature-tunable coating may be applied to a variety of substrates depending on the application. With the use of the optical carrier signal, its temperature may then be remotely and precisely determined.

The following description provides an overview of the IR camera system, followed by a more detailed characterization of each of the camera components. The description further presents the various manufacturing techniques used to fabricate the camera components, and finally describes other uses of the underlying concepts of the camera system.

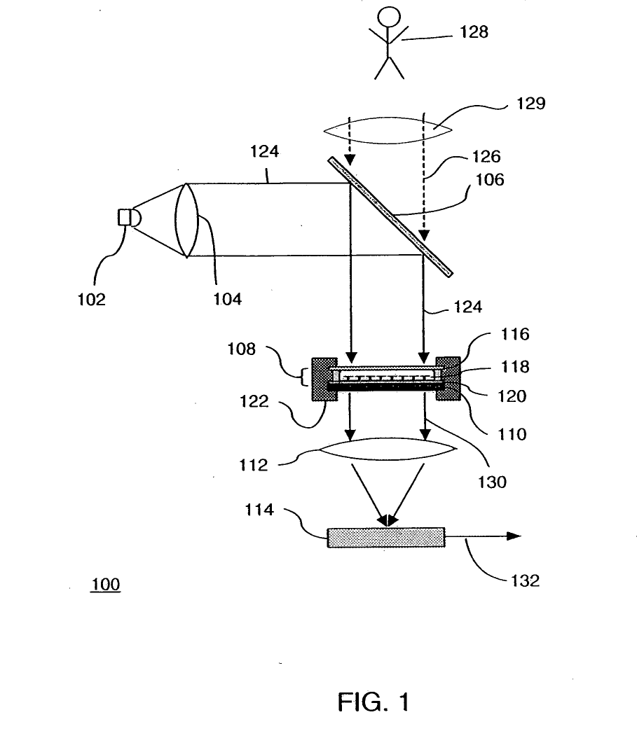

FIG. 1 shows the described embodiment of an IR camera system 100, including an NIR source 102, a collimating lens 104, a reflector 106 (transparent or nearly transparent in the IR wavelength range), a focal plane array (FPA) 108, a reference filter 110, a focusing lens 112, and an NIR detector array 114. FPA 108 includes an IR window 116, and an array of pixel elements 118 mounted on a substrate 120. IR window 116, pixel elements 118, substrate 120 and the reference filter 110 are all packaged in a vacuum-sealed unit, the temperature of which may be maintained by a thermo-electric cooler (TEC) 122. As is described herein, if the tunability coefficients of the FPA 108 and the reference filter 110 are the same or nearly the same, the TEC 122 may be omitted.

Collimating lens 104 forms the light from NIR source 102 into a collimated beam 124, which reflects off of reflector 106 to the IR window of FPA 108. Collimated beam 124 passes through FPA 108 and through focusing lens 112. Focusing lens 112 focuses the NIR light from FPA 108 onto NIR detector array 114. IR light 126 from the scene to be imaged 128 is focused with IR lens 129, passes through the reflector 106, though the IR window 116 and onto the array of pixel elements 118. Since the process of making the FPA is compatible with a silicon fabrication process, FPA can be directly deposited and fabricated on the CCD or CMOS sensor to get maximum integration. With such an architecture, the NIR lens may be omitted.

Each one of the array of pixel elements 118 is a thermally-tunable optical filter that processes the NIR light passing through with a filter characteristic that is a function of the temperature of the pixel element. IR light 126 projected onto the array of pixel elements 118 is converted to thermal energy via an IR absorbing layer (described herein) deposited on the surface of each pixel element. The pixel elements 118 can be made of a material that absorbs the incident radiation, so that an additional absorbing material is not necessary. The resulting thermal energy creates local temperature variations across the array of pixel elements 118, so that each individual pixel filters the NIR light passing through the pixel according to the local temperature at that pixel. The two-dimensional filtering pattern of the array of pixel elements 118 is thus directly related to the IR energy arriving from the scene 128 that is being imaged.

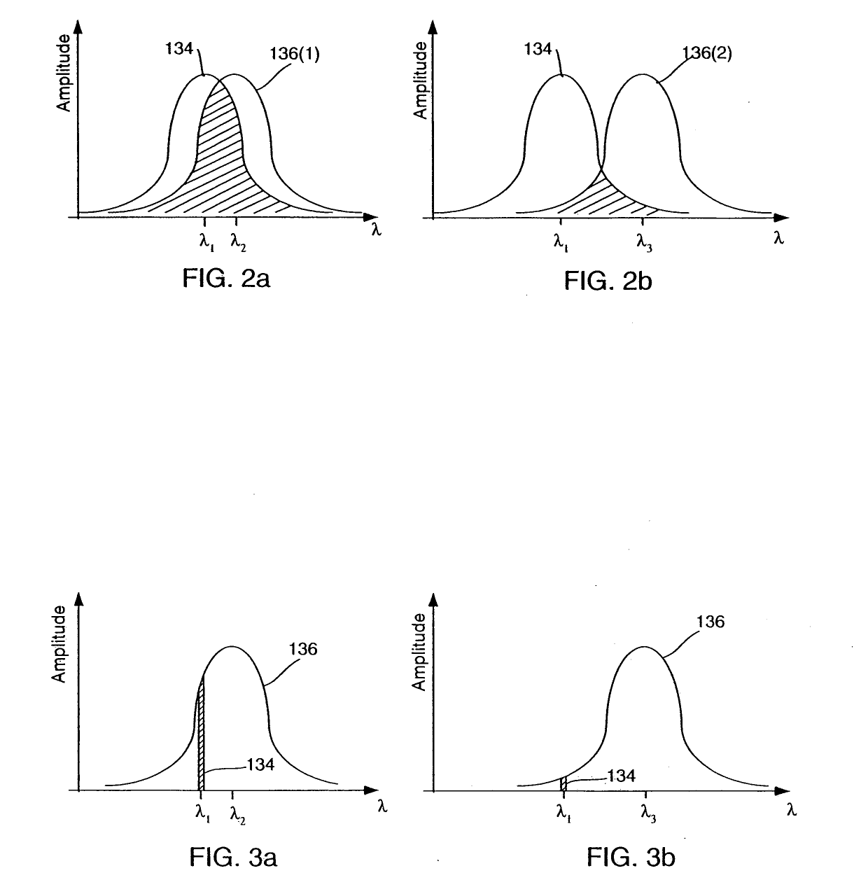

FIGS. 2a and 2b illustrates the filtering characteristics of an individual pixel element with respect to temperature (other aspects of these figures are explained below). FIG. 2a shows the filtering spectrum 136(1) centered at λ₂, of a pixel element at a first temperature T₁. FIG. 2b shows the filtering spectrum 136(2) centered at λ₃, of the same pixel at a second temperature T₂. Comparing FIGS. 2a and 2b shows that as the temperature of the pixel element changes, the filtering spectrum of the pixel element merely shifts in wavelength, with little or no change in shape or amplitude.

Generally, narrowing the bandwidth of the NIR light 124 increases the detection resolution of wavelength shifts of the filter spectrum 136(1). However, the slope of the filters spectrum is directly related to the responsivity of the pixel element, so one can make the pixel element with a multi-cavity filter, providing a very steep slope in the filter spectrum while the bandwidth is not necessarily narrow. After the array of pixel elements 118 filters the incoming NIR light 124, the filtered NIR light 130 passes through the reference filter 110, which passes only a narrow bandwidth of the filtered NIR light 130. FIG. 2a shows the filtering spectrum 134 of the narrowband NIR light (i.e., the spectrum of the reference filter) and the filtering spectrum 136(1) of one of the pixel elements in the array of pixel elements 118. The shaded overlap region represents the wavelength spectrum of the NIR light that reaches the NIR detector 114. FIG. 2b shows the same two spectra with the spectrum 136(2) of the pixel shifted from λ₂ to λ₃ due to a change in the incident IR energy. The amount of change in the shaded overlap region is indicative of the amount of change in the incident IR energy. FIGS. 3a and 3b show the same change in IR energy but with a reference filter 110 having extremely steep slope (approaching that of a laser) with a narrower wavelength spectrum 134. Comparing FIGS. 2a and 2b to FIGS. 3a and 3b shows that it is easier to detect a given change in IR energy with IR light having a steep sloped spectrum because of a greater percent difference in the overlap for the same change in IR energy.

The reference filter 110 is a thermo-optically tunable narrow band filter with a center wavelength at (for example) 850 nm, and a fixed bandwidth of (for example) 0.5 to 0.9 nm. The reference filter 110 is in close proximity to the array of pixel elements 118, so that the temperature of the reference filter 110 and the array of pixel elements 118 will closely track one another to reduce errors due to different ambient temperatures.

Following the reference filter 110, the filtered NIR light 130 passes through the focusing lens 112, which focuses the filtered NIR light 130 onto the NIR detector 114. The NIR detector 114 produces an electrical signal 132 corresponding to the two-dimensional image of NIR light projected by the focusing lens 112. The focusing lens 112 may be eliminated in some cases, for instance when the FPA 108 is stacked directly on the NIR detector 114. The focusing lens 112 may also be used to “blow up” or enlarge the image of the FPA 108 so that a large NIR CCD or CMOS array can be used for the NIR detector 114 to increase the signal-to-noise ratios (SNRs) in the projected image. The SNR can be increased by corresponding multiple CCD or CMOS pixel elements to one “displayed” thermal pixel, i.e., by using the combined signals from multiple CCD or CMOS pixel elements to reduce the inherent CCD or CMOS noise via digital image processing techniques known in the art such as filtering, averaging, etc.

The overall performance of the thermal imager may be modeled as follows:

IR radiation power from scene environment: P_{IR}=σTₑ⁴

Power absorbed by IR absorber: P_{α}=P_{IR}·α_{IR}·A

Pixel element filter temperature without IR illumination: T_{f0}

Pixel element filter temperature with IR absorption:

$${T}_{f} = \frac{{P}_{a}}{K} + {T}_{f 0}$$

Pixel element filter temperature change: ΔT_{f}=P_{α}/K

Pixel element filter wavelength without IR illumination: λ_{f}(T_{f0})

Pixel element filter wavelength with IR illumination:

$${λ}_{f} ( {T}_{f} ) = {λ}_{f 0} + \frac{d {λ}_{f}}{{T}_{f}} \cdot Δ {T}_{f}$$

Pixel element filter transmission at the reference wavelength: I_{f}=I_{f}(λ_{f})

The modulated optical signal power: Pₘ=Pᵣ·Iᵣ·I_{f}

Therefore, if the temperature of the scene environment changes, the NIR optical signal after the FPA will be modulated, and hence the NIR can detect the change:

$$Δ {P}_{m} = {P}_{r} \cdot {I}_{r} \cdot \frac{ⅆ {I}_{f}}{ⅆ {λ}_{f}} \cdot \frac{ⅆ {λ}_{f}}{ⅆ {T}_{f}} \cdot \frac{{α}_{IR} \cdot {T}_{e}^{3} \cdot A}{K} \cdot Δ {T}_{e}$$

The relative change of the NIR signal is

$$\begin{matrix}\frac{Δ {P}_{m}}{{P}_{m}} = \frac{{P}_{r} \cdot {I}_{r} \cdot \frac{ⅆ {I}_{f}}{ⅆ {λ}_{f}} \cdot \frac{ⅆ {λ}_{f}}{ⅆ {T}_{f}} \cdot \frac{{α}_{IR} \cdot {T}_{e}^{3} \cdot A}{K} \cdot Δ T}{{P}_{r} \cdot {I}_{r} \cdot {I}_{f} ( {λ}_{f 0} )} \\ = \frac{\frac{ⅆ {I}_{f}}{ⅆ {λ}_{f}} \cdot \frac{ⅆ {λ}_{f}}{ⅆ {T}_{f}} \cdot \frac{{α}_{IR} \cdot {T}_{e}^{3} \cdot A}{K}}{{I}_{f} ( {λ}_{f 0} )} \cdot Δ T\end{matrix}$$

The sensitivity of the overall IR camera system 100 depends on the sensitivity of the NIR detector array. Assume the sensitivity of the NIR detector array is η (e.g., 10⁻³ etc), then the system's noise equivalent temperature difference (NETD) is

$$\begin{matrix}NETD = \frac{{I}_{f} ( {λ}_{f 0} )}{\frac{ⅆ {I}_{f}}{ⅆ {λ}_{f}} \cdot \frac{ⅆ {λ}_{f}}{ⅆ {T}_{f}} \cdot \frac{{α}_{IR} \cdot {T}_{e}^{3} \cdot A}{K}} \cdot η \\ = \frac{1}{\{ \frac{ln ( 10 )}{10} \cdot \frac{ⅆ [ 10 \cdot log ( {I}_{f} )}{ⅆ {λ}_{f}} {\vert}_{{λ}_{f 0}} \} \cdot \frac{ⅆ {λ}_{f}}{ⅆ {T}_{f}} \cdot \frac{{α}_{IR} \cdot {T}_{e}^{3} \cdot A}{K}} \cdot η\end{matrix}$$

From the equation above, it is apparent that steeper slopes in filter transmission, higher temperature tunability in the filter, and smaller thermal leakage from the pixel element are the important pixel parameters driving a small NETD. A small NETD results in greater temperature resolution and better sensitivity for the camera system 100, and thus better overall quality of the thermal image.

The tunable Fabry-Perot filters used in the FPA have been shown to exhibit transmission slopes of up to 30 dB/nm. At a center wavelength of 850 nm, for which low-cost optical carrier sources are commonly available and for which low-cost silicon CMOS and CCD imagers are applicable, wavelength tunability (with respect to temperature) of these filters has been shown to be roughly 0.06 nm per degree.

For example, assume that the silicon oxide or silicon nitride material (or alternatively a polymer material) used for the pixel post in the described embodiment typically has a thermal conductivity of 0.1 W/m·K. In the described embodiment, the post is 5 microns in diameter and 10 microns high, resulting in a thermal conductivity of 2×10⁻⁷ W/K. In the described embodiment each pixel has a surface area of 625 microns², resulting in a noise equivalent temperature difference of:

$$NETD = \frac{4.3 e 9 \cdot η}{{α}_{IR} \cdot {T}_{e}^{3}}$$

Assuming a pixel absorptivity of 70%, CMOS or CCD imager sensitivity of 1/2000, scene background temperature of 300K, the resulting NETD is 0.11K. NETD is improved drastically with increasing scene background temperature. When Tₑ is 700K, NETD is 9 mK. This means the camera can detect much finer details of a hot object than a cold object. Furthermore, increases in pixel size, imager sensitivity, or pixel insulation may all be used to further increase the temperature resolution of the thermal imager.

Ultimately, because the achievable responsivity of the thermo-optically tunable narrow band filter is on the order of 100%/K, an imaging system built using this optical filter system can be constructed to have significantly higher temperature resolution as compared to the 2.5%/K typical in uncooled bolometer array imagers. Alternatively, this advantage may be used to further simplify the design and manufacturing process in order to maximize process yield and reduce product cost.

The relatively high temperature resolution of the thermal sensor upon which the IR camera is based may also be used to in other applications, which will be described in more detail below.

NIR Source

The described IR camera system 100 relies on narrowband NIR light to detect changes in the energy of the IR light 126 from the scene to be imaged 128. In the described embodiment, the NIR source 102 is a light emitting diode (LED) that produces moderately wideband NIR light centered at approximately 850 nm. The LED, coupled with the reference filter 110 following the FPA 108, produces narrowband NIR light at the detector array 114.

Though reference filter 110 is located behind FPA 108, reference filter 110 can be situated anywhere in the NIR optical path between the LED and NIR detector array 114. The advantage of placing reference filter 110 in close thermal proximity to FPA 108 is that its temperature will closely track the temperature of FPA 108. If the tunability coefficients of the FPA and the reference filter are the same or nearly the same, it is not necessary to control their temperatures with a TEC or other similar device. Temperature tracking between the reference filter 110 and FPA 108 is important because a change in temperature of either filter 110 or FPA 108 (without a corresponding change in temperature of the other) creates a change in the overlap region shown in FIGS. 2a and 2b. The camera system 100 will mistake this change in the overlap region for a change in incident IR radiation. Therefore situating the reference filter 110 elsewhere, for example immediately after LED 102, may requires a thermoelectric cooler for reference filter 110, along with feedback circuitry between FPA 108 and reference filter 110, so that the temperatures of the two components will closely track one another.

Instead of using a broadband source with a reference filter, one could use a laser transmitting light at approximately 850 nm. Since a laser produces a sufficiently narrowband spectrum with a very steep slope, a reference filter would not be needed to further narrow the NIR spectrum. Although this extremely narrow spectrum results in high sensitivity to IR variations (as described above), feedback circuitry between the some types of lasers and the FPA may be necessary to guarantee that the temperature of the laser and the FPA track one another, so that the center wavelength of the light from the laser tracks the passband of the FPA filters. The wavelength of most semiconductor lasers tune with temperature. Some lasers, such as some vertical cavity surface emitting lasers (VCSELs), shows tunability (change in wavelength with respect to temperature, i.e., nm/K) very close to the tunability of the FPA filter, thereby one can eliminate the need for such feedback circuitry with a calibration process to avoid the adverse effect of ambient temperature change.

Focal Plane Array (FPA)

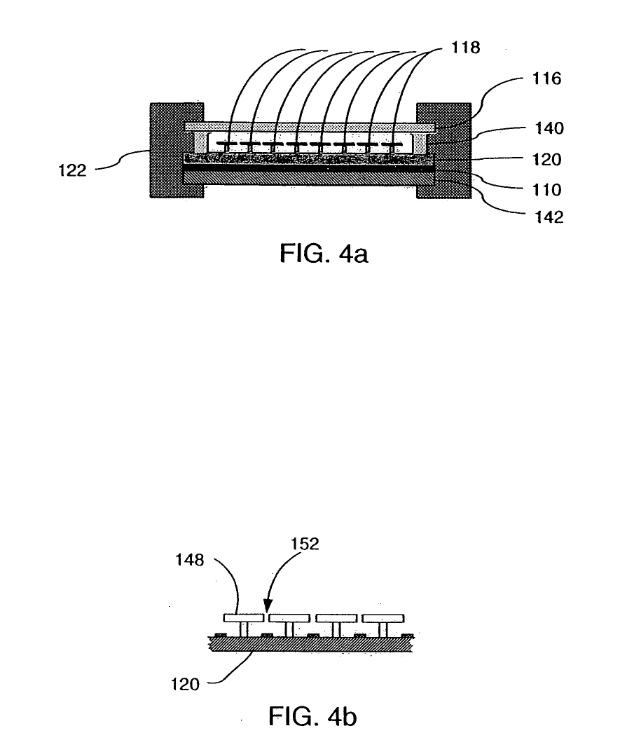

A cross-section of the FPA package 108, packaged in vacuum is shown in FIG. 4a. The FPA 108 includes an IR window 116 that is transparent to IR and NIR radiation, so as to allow IR light from the scene 128 and NIR light 124 from the NIR source 102 to pass unimpeded or nearly unimpeded to the underlying components of the FPA 108. The IR window 116 also provides a hermetic boundary at the top surface of the FPA 108 package. The described embodiment uses a ZnSe window coated on both sides to reduce reflectance of IR light. The coating is transparent or nearly transparent to both IR and NIR light.

The basic components of FPA 108 include a substrate as supporting base for all the pixels, thermally-tunable optical filter as sensing element, a small thermal conduction path to substrate, and material for absorbing IR light to generate heat into filter (this material may be the filter itself). One structure of the FPA is shown in FIG. 4a.

The FPA 108 includes an array of pixel elements 118, each of which is supported by a post 146 having low thermal conductivity that thermally isolates the pixel from the supporting substrate 120. FIG. 5 shows a top view of a portion of the array of pixel elements 118. Each individual pixel 148 is hexagonal in shape, with the single supporting post 146 shown as a broken-lined circle. In the described embodiment, the width 150 of the pixel is approximately 50 μm, and the diameter of the post is approximately 5 μm. Trenches 152 between the pixels 148 thermally isolate the pixels 148 from one another to prevent thermal crosstalk. The thermal isolation provided by this structure results in an enhanced sensitivity of the pixels elements 118 to incident IR radiation.

NIR light that passes through the trenches 152 between the pixels elements is not modulated by the thermally-tunable optical filtering of the pixel elements, and therefore can dilute or interfere with the modulated signal detected by the NIR detecting array 116. A reflecting layer 200 is deposited on the substrate 120 only in the region directly below the trenches 152 between the individual pixels 148, as shown in FIG. 4b. The reflecting layer prevents this unmodulated NIR light from passing through the substrate, without interfering with the modulated light passing through the pixels. The reflective layer 200 is used when the FPA is to be used in a transmissive mode, i.e., when NIR light passes through the FPA. An absorptive layer or anti-reflection coating layer could be used in place of this reflective layer when the FPA is used in a reflective mode. Such a reflective, absorbing, or anti-reflection coating layer could be metal, oxidized metal, or dielectric multi-layer coatings, and when the streets are very narrow (resulting in high fill factor), this layer is not needed. One can also use this layer to enhance the responsivity of the filter, for instance, using this reflective layer as one mirror, the air gap and bottom layer of the pixel element as a cavity, and another mirror in or on the pixel element. One can also use the air gap and pixel filter to form a multi-cavity filter.

Substrate 120 supporting the array of pixel elements 118 is transparent to NIR light so that the NIR beam modulated by the pixels can pass through the FPA 108. The substrate 120 also has high thermal conductivity to provide a good thermal ground plane for the pixels 148. The substrate 120 thus distributes heat from a particular pixel or group of pixels to prevent thermal biasing of neighboring pixels. In the described embodiment, the substrate 120 is made of optical grade sapphire. The substrate 120 includes an anti-reflective coating on the non-FPA side (i.e., the side of the substrate that will not support a pixel array). This coating increases the amount of NIR light reaching the NIR detector array 114 and reduces fringes in the FPA filter spectrum caused by reflectance. The FPA side of the substrate may also include an anti-reflective coating. This coating is chosen to be anti-reflective in the NIR wavelength range, and highly-reflective in the IR range, providing a “double pass” for the IR light for higher absorption. The substrate is not limited to sapphire. In transmission mode, any substrate which is thermally conductive and transparent to NIR can be used, and (as described herein) the CMOS or CCD detector could be used as substrate. In reflective mode, the substrate does not need to be transparent to NIR, so that for example a silicon wafer can be used.

The IR window 116 is bonded to the pixel array substrate 120 with a metal frame 140 disposed about the perimeter of the array of pixel elements 118. The metal frame 140 is made of indium (or other soldering material), which bonds to the IR window 116 and the substrate 120 when subjected to the proper temperature and pressure conditions during fabrication. Details of this bonding process and other FPA fabrication steps are provided below in a section describing FPA vacuum packaging.

Reference filter 110 is deposited on a reference filter substrate 142 and is situated against the back of the pixel array substrate as shown in FIG. 4a. FPA 108 (i.e., the IR window 116 bonded to the pixel array substrate 120) and reference filter 110 on the reference filter substrate 142 are packaged within a TEC 122. This TEC 122 maintains the temperature of FPA 108 and reference filter 110 at a constant or nearly constant temperature. The particular temperature is selected to reduce or eliminate a temperature difference between the reference filter 110 and the FPA 108, or to increase the dynamic range of the system if the reference filter is a fixed filter (i.e., does not vary with temperature). If the tunability coefficients of the FPA 108 and the reference filter 110 are the same or nearly the same, the TEC 122 is not needed.

The NIR detector array 114 is a commercially available CCD or CMOS camera that receives the filtered NIR beam 130 and produces an electrical signal representing the two dimensional image projected onto the array 114 via the NIR beam 130 from the FPA 108. The NIR detector array 114 has a pixel structure that can be produced by a very simple and high-yield fabrication process. Further, such detector arrays are commercially well-developed, are rapidly evolving and improving, and are generally considered a commodity item. The NIR detector array 114 is consequently less expensive and easier to manufacture as compared to detector arrays in commercially available IR imaging systems.

Pixel Posts

The small path of thermal conduction from the pixel element to the substrate can be completed with a variety of designs and materials. In the described embodiment, the pixel posts 146 are hollow. Increasing the thermal isolation of the pixels 148 increases the sensitivity of the pixels 148 to incident IR radiation. The hollow posts 146 are a key contributor to thermally isolating the pixels 146.

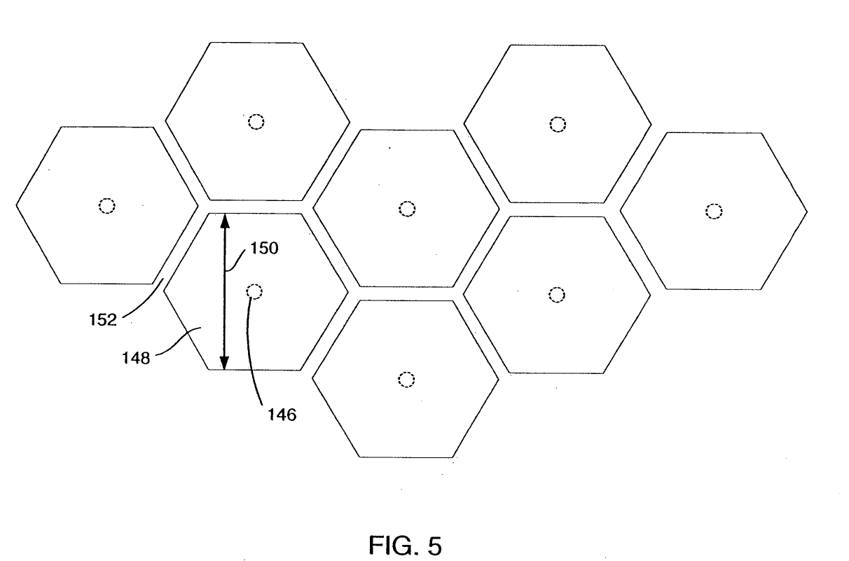

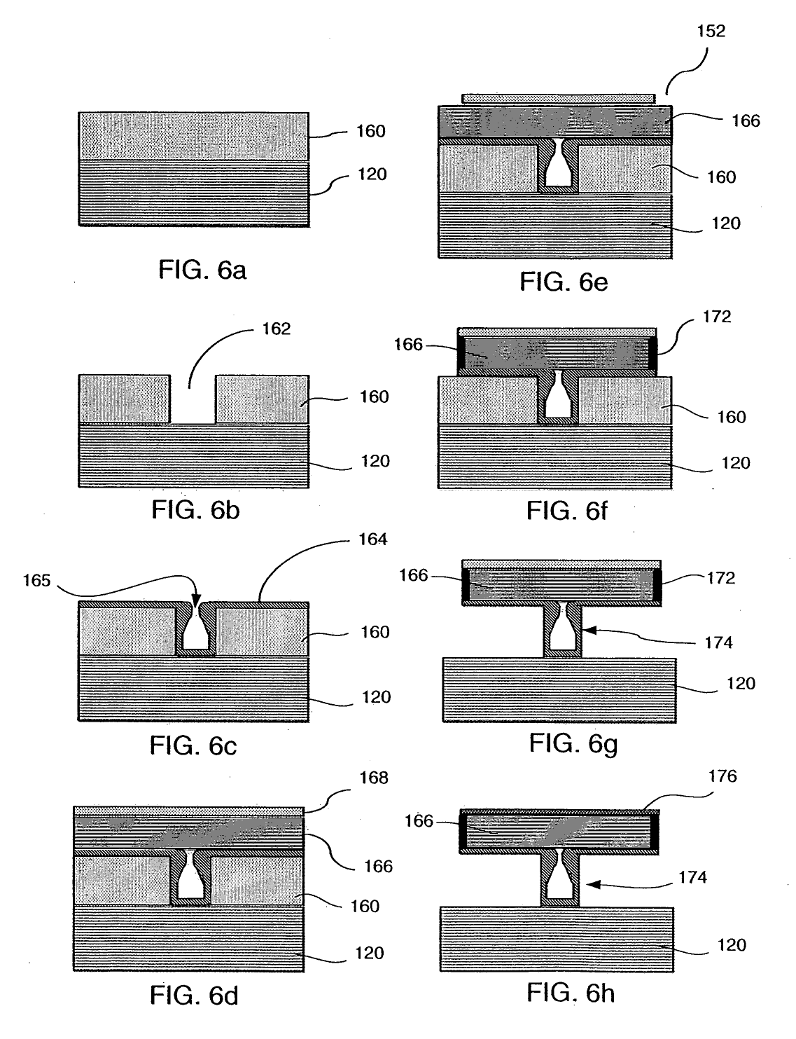

FIGS. 6a through 6h illustrate the process for fabricating the pixel posts 146 described above.

Initially, a layer of Ti on the FPA side of the substrate 120 (i.e., the side that will support the pixel array 118) is used to promote adhesion of subsequently deposited materials through the thermal cycles experienced during deposition processing. A sacrificial layer 160 is then deposited onto the substrate 120, as shown in FIG. 6a. In the described embodiment, the substrate 120 is made of sapphire and the sacrificial layer 160 is made of a material that has a higher etch rate than sapphire (e.g., silicon nitride (SiNx), polyimide, etc.).

After the sacrificial layer has been deposited, a post hole 162 is etched vertically down into the sacrificial layer, as shown in FIG. 6b, using for example a deep reactive ion etch (DRIE) process such as the “Bosch” process. This process uses an alternating series of vertical etching and passivation steps, so that the side walls of the post hole 162 are protected from further lateral etching by a polymer layer. The sacrificial layer may be a polymer material. If the polymer is photosensitive, the post hole 162 can be etched with a chemical etching process after the holes have been defined using photolithography techniques known in the art.

A protection layer 164 of silicon dioxide (SiOx) is then conformally deposited onto the sacrificial layer and the post hole 162, as shown in FIG. 6C. The protection layer 164 could alternatively be made of other materials with low thermal conductivity (e.g. amorphous Si, silicon nitride, or a great variety of other materials would qualify). The protection layer has an optical thickness of an even number (typically 2 or 4) of quarter wavelengths of the NIR light. Parameters of the deposition process (e.g., temperature, pressure, flow rates, etc.) can be controlled to cause the protection layer 164 to “pinch off” 165 near the top of the post hole 162, thus leaving a void within the post hole 162. Pinch off is caused by thickening of the protection layer 164 at the top of the post hole 162, so as to close or nearly close the post hole 162. This pinch off effect may be enhanced by shaping the sidewalls of the post hole 162 (e.g., undercutting so that the diameter of the hole gets larger as the hole depth increases), although pinch off can be made to occur in a cylindrical hole by tailoring the associated deposition process.

After completing this conformal deposition, the filter 166 is fabricated on the protection layer 164, as shown in FIG. 6d. In this embodiment, the filter is a multilayer structure such as is described in U.S. patent application Ser. No. 10/666,974 entitled “Index Tunable Thin Film Interference Coating,” which is hereby incorporated by reference. A large number of variations are possible to achieve various responsivities and time constants in the FPA. The described embodiment uses a simple single-cavity Fabry-Perot structure deposited from amorphous Silicon (a-Si) and amorphous Silicon Nitride (a-SiNx). Four-pair mirrors are sufficient to provide a narrow filter function with acceptable insertion loss: four pairs of quarter-waves (NIR) a-Si+a-SiNx, then a cavity (or “defect”) of 4 quarter waves of a-Si, and then four pairs of quarter-waves a-SiNx+a-Si. These layers are grown using a PECVD process that provides high-grade a-Si semiconductor material (corresponding to low optical loss in the NIR range), and under growth conditions that promote resistance to RIE when compared to the sacrificial a-SiNx layer.

After depositing the filter 166 onto the substrate 120, a masking layer 168 (e.g., aluminum) is then deposited. The pinch off 165 at the top of the post hole 162 keeps the filter layer 166 planar at the top of the post hole 162, and prevents the filter layer from extending down into the post. This is important because if the filter layer 166 extends down into the post, the masking layer may not be continuous over the surface of the filter, i.e., an aperture in the masking layer 168 may form at the post hole, allowing the etchant in the subsequent processing steps to attack the filter material in the immediate region around the post. As described above, the pinch off at the top of the post hole 162 does not need to be complete, as long as the pinch off region is narrow enough to prevent the filter 166 from extending significantly into the post hole 162.

The masking layer 168 is then patterned to define a network of narrow trenches 152 that isolate individual pixels, as shown in FIG. 6e. The filter 166 and the protection layer 164 is vertically etched by using a dry etch process, as shown in FIG. 6f. More specifically, a reactive ion etch is used in which the etch gas is, for example, a combination of CHF₃ and O₂. The reaction between these gases, the plasma used in the process, and the filter material that is being removed naturally forms a protective layer (e.g. a polymer 172) on the sidewalls of the remaining island of optical filter 166. The polymer material 172 protects the optical filter from being etched laterally as the etching continues vertically.

Next, the etching conditions are changed and the sacrificial layer 160 is laterally etched away, as shown in FIG. 6g. More specifically, after the optical filter 166 is etched the etch gases are switched to CF₄ and O₂ which produces an isotropic etch in the sacrificial SiNx layer. Other etching recipes can be used for other sacrificial materials, for instance, using oxygen plasma to etch polymer or polyimide, or using wet etch process for metal, polymer, SiNx, etc.

The etching stops at the protection layer 164. This process results in the formation of a hollow post 174. The masking layer 168 is removed with an appropriate etching process, and an IR absorbing layer 176 may be deposited on the surface of the pixel 148, as shown in FIG. 6h. In some cases, the filter material itself is chosen to be IR-absorbing (or absorbing in the wavelength range of interest), in which case an absorbing layer 176 is not necessary. In the described embodiment the absorbing layer is a thick layer of silicon nitride, although a transparent conductive oxide or other IR absorbing material known in the art can be used for the absorbing layer 176.

The main advantages of the hollow post structure is very low thermal leakage and mechanical robustness. Because the post 174 is hollow and the heat is only conducted along a thin cylindrical shell, the thermal leakage from the pixel 148 to the substrate 120 is very low.

In order to decrease the thermal conductivity of the pixel post 174, the composition of the protection layer 164 may be varied to increase its porousness. For example, a silicon oxygen carbide material may be used. Alternatively, the protection layer 164 may be doped with any one of a wide variety of dopants known in the art to decrease its thermal conductivity, or the post walls can be scored or otherwise textured to reduce their thermal conductivity.

The thickness of the sacrificial layer 160 (and consequently the height of the resulting space between the filter layer 166 and the substrate) affects the performance of the FPA. This is because the substrate 120 is not perfectly transparent, and some portion of the NIR light passing through the filter layer 166 toward the substrate 120 reflects back to the filter 166. The thickness of the sacrificial layer is therefore chosen (based on the wavelength range of the NIR light) to make the space between the filter layer 166 and the substrate 120 an “absentee layer” (e.g., even number of quarter wavelengths of the NIR light) that will not support resonances at the NIR wavelength. The space between the filter layer 166 and the substrate 120 can also be designed as one of the layers in the filter stack in a multi-cavity filter architecture to further enhance the responsivity of the filter.

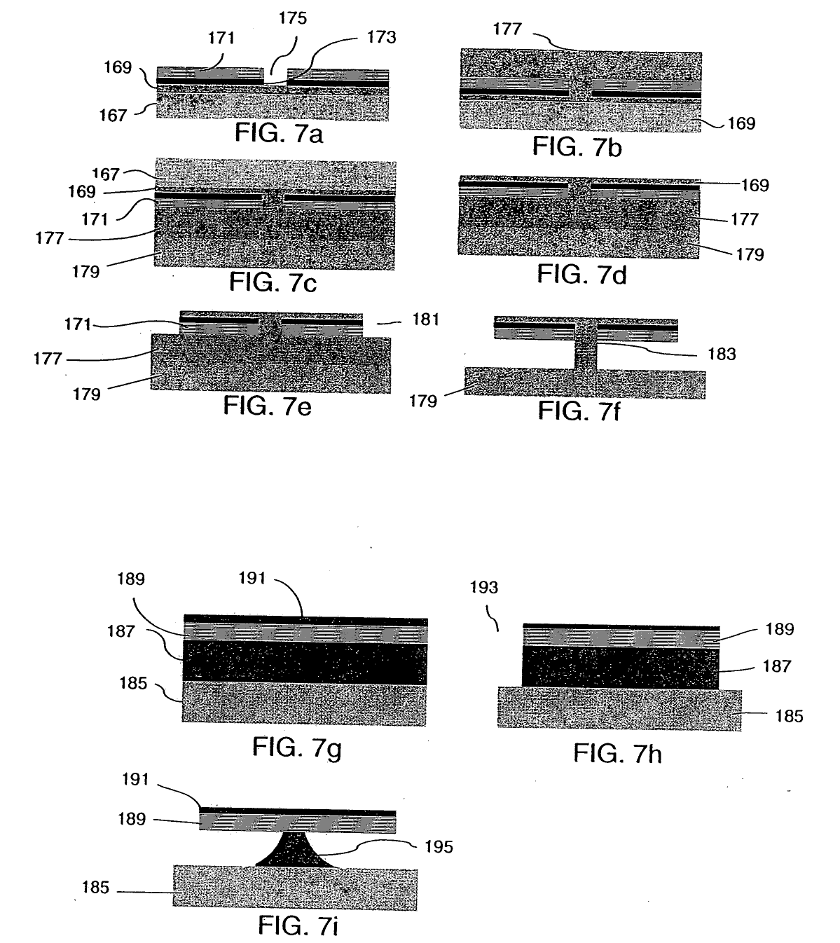

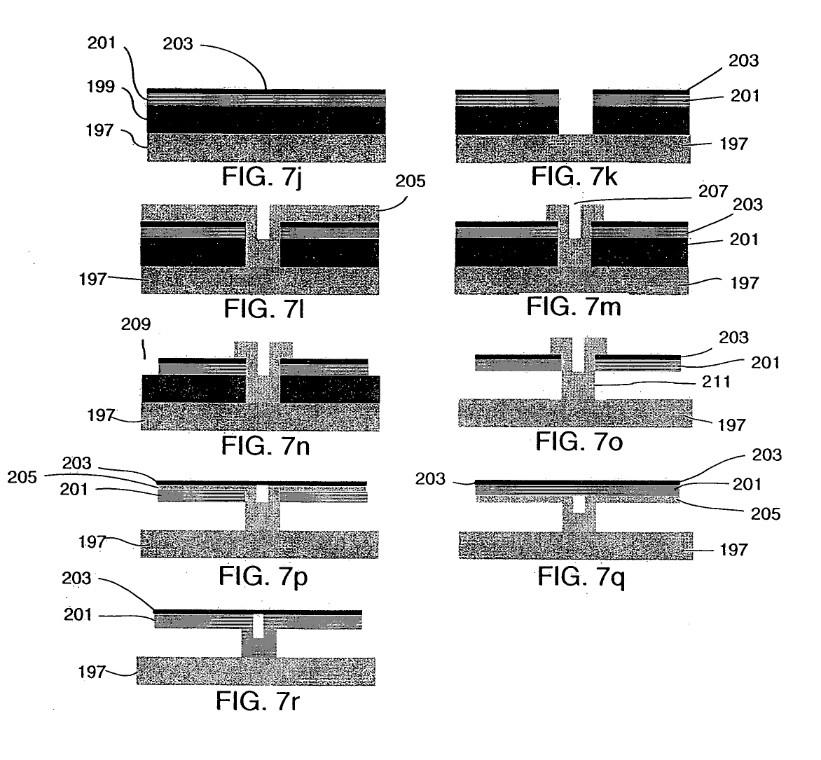

Other techniques may be used to fabricate the pixel element and post structures. For example, FIGS. 7a through 7f illustrate a process for fabricating a pixel with a solid post. In FIG. 7a, absorber 171 and filter 173 are grown on the oxide layer 169 of oxidized silicon wafer 167 or handle wafer, and then filter 173 and absorber 171 are patterned and etched so that the a hole 175 is etched into the center of each pixel element. The oxide layer 169 acts as an etch stop so that the etching of the filter 173 and absorber 171 can be well controlled. In FIG. 7b, a thermal insulting and UV sensitive material 177, (for instance, SU8 photoresist) are deposited on the wafer 167. In FIG. 7c, another wafer 179 is bonded to the thermal insulting and UV sensitive material 177, and thus absorber 171, filter 173, thermal insulator 177 are sandwiched between two wafers (167 and 179), the whole sample is flipped over for further processing. In FIG. 7d, the silicon of the handle wafer 167 has been removed by combination of polishing and chemical or dry etching. Again oxide layer 169 acts as etch stop. In FIG. 7e, the sample is exposed to UV so that the SU8 photoresist becomes etch-selective between exposed and unexposed part. The filter 173 is used as a photomask because filter material (amorphous silicon) is not transparent to UV. SU8 is a negative material, so after UV exposure the SU8 in the original opening hole 175 and underneath become harder than areas not exposed to UV. Then, oxide layer 169, filter 173, and absorber 171 are patterned and etched into individual pixels with trenches 181 around each pixel element. In FIG. 7f, unexposed SU8 areas are removed, leaving a floating pixel connected to substrate by a post 183.

Another example of a fabrication technique is shown in FIGS. 7g through 7i. In FIG. 7g, a thick silicon nitride layer 187 or other material is grown on substrate 185, and filter 189 and absorber 191 are grown afterwards. In FIG. 7h, absorber 191 and filter 189 are patterned and etched so that each pixel is surrounded by a trench 193. The silicon nitride layer 187 can be etched vertically as well at this stage, but the backside of the filter is not etched. In FIG. 7i, silicon nitride layer 187 is etched isotropically so that only a central post 195 is left underneath the filter 189.

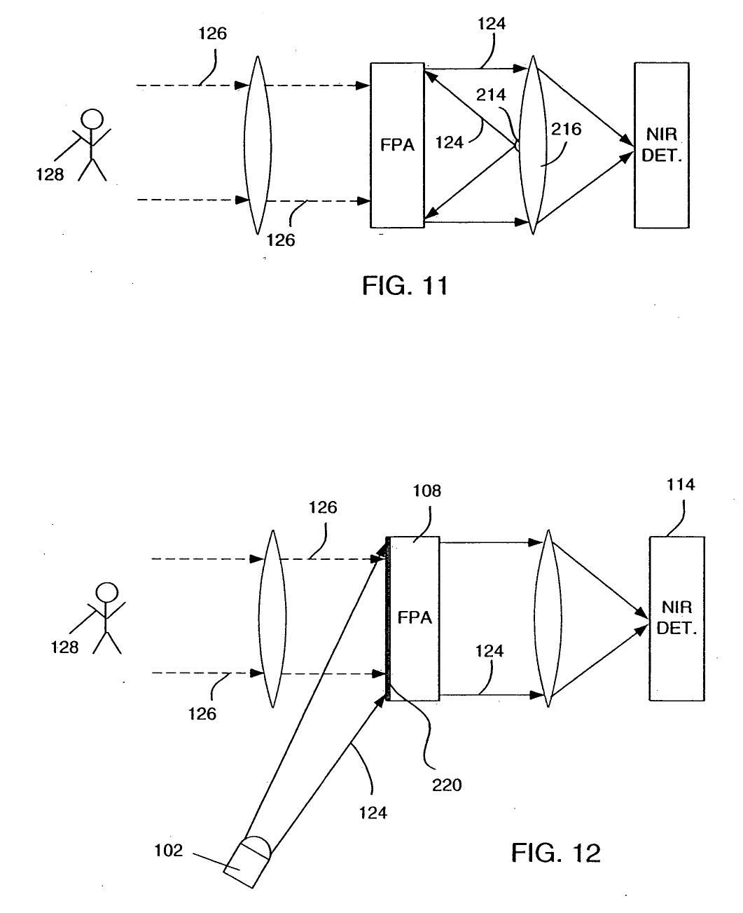

Yet another fabrication technique is shown in FIGS. 7j through 7r. In FIG. 7j, absorber 203, filter 201 and sacrificial layer 199 are deposited on substrate 197. In FIG. 7k, absorber 203, filter 201, and sacrificial layer 199 are patterned and etched into an array of holes. In FIG. 71, a layer of thermal insulating material 205 such as silicon dioxide is conformally deposited across the wafer. In FIG. 11m, the insulating material 205 is patterned and etched so that a SiO₂ post with air plug 207 is left. In FIG. 7n, absorber 203 and filter 201 are patterned and etched into individual pixels elements, creating trenches 209 between the pixel elements. In FIG. 7o, sacrificial material is removed, leaving a pixel element standing on the post 211.

This process can be varied in a number of ways. The results of several such variations are illustrated in FIGS. 7p, 7q and 7r. In FIG. 7p, absorber is deposited after the SiO₂ layer is etched. This approach results in more robustness and better fill factor. In FIG. 7q, both the filter and the absorber are deposited on the sacrificial layer. In FIG. 7r, the filter itself is used as post.

Vacuum Packaging of the FPA

Once the array of pixel elements 118 has been fabricated on the substrate 120, the array of pixel elements 118, substrate 120 and IR window 116 is vacuum packaged as a single unit to form the FPA 108.

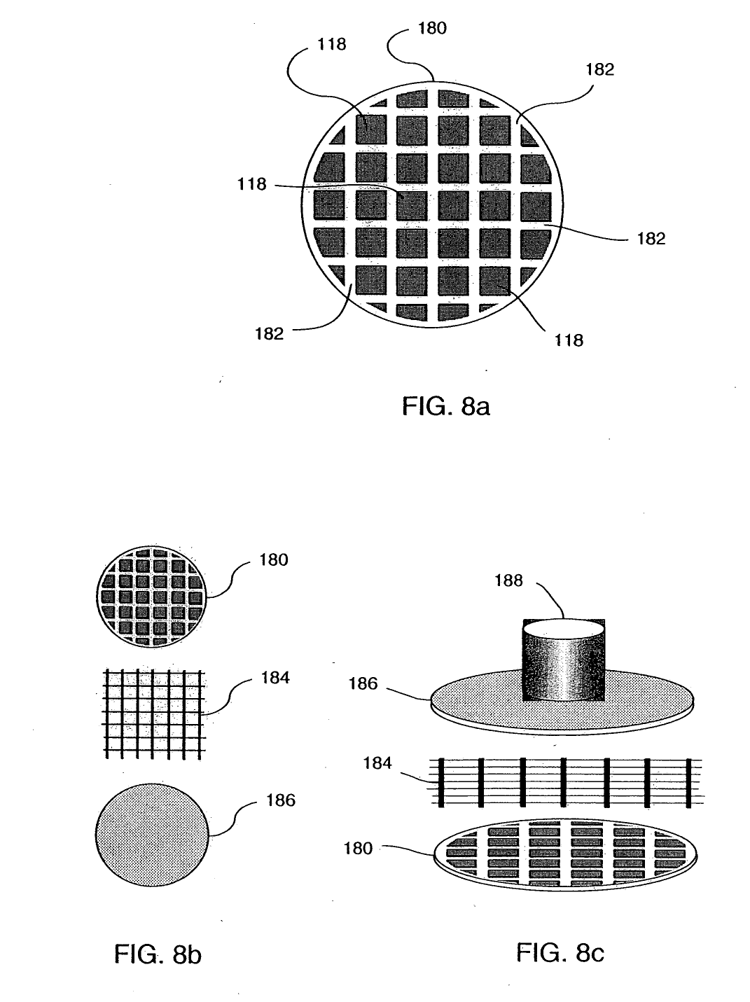

FIG. 8a shows a prefabricated wafer 180 upon which a number of pixel arrays 118 have already been deposited and fabricated. The individual arrays 118 are separated by “empty streets” 182 that are simply wide strips of bare substrate 120 without pixels, posts or other structures.

Components used for vacuum packaging, shown in FIG. 8b, include the prefabricated wafer 180, an sealing frame 184, and an IR window disc 186. The sealing frame 184 is formed by molding or other techniques known in the art (e.g., thin film deposition), so that the horizontal and vertical members of the frame 184 correspond to the streets 182 on the wafer 180.

The sealing frame 184 (made of indium, although alternative solder materials may be used) and the wafer 180 are aligned so that the sealing frame 184 fits into the streets 182 between the pixel arrays 118 on the wafer 180, and the IR window disc 186 is placed on top of sealing frame 184, as shown in FIG. 8c. This “sandwich” structure is placed in a vacuum oven that is pumped down to a pressure significantly below atmospheric pressure and is then heated to a temperature at which the indium frame softens and begins to bind to the wafer 180 and IR window disc 186. A weight 188 placed on top of the IR window disc 186 controls the amount of spreading of the softened indium frame. Under these conditions, the sealing frame 184 becomes tacky and will stick to the surfaces of wafer 180 and IR window disc 186. The temperature of the oven is then reduced so that the sealing frame 184 hardens. The wafer 180, the sealing frame 184 and the IR window 186 thus form a vacuum sealed array of FPAs, which is then sectioned into individual FPA units, one of which is shown in FIG. 4.

Small leaks in the package and outgasing of deposition layers can degrade the vacuum within the FPA 108. As the vacuum degrades, thermal conduction away from the pixel elements increases and decreases their sensitivity. To mitigate small leaks and outgasing, a getter material is deposited onto selected surfaces within the FPA package prior to vacuum sealing. The getter material acts to capture the extraneous gas to transform the gas into a solid, thereby keeping the pressure within the FPA package (and consequently the thermal isolation) low. Appropriate getter materials are well known in the art.

An outline of one procedure for fabricating and packaging an FPA is included in APPENDIX A. This procedure produces a solid pixel post, and dices the wafer prior to defining the pixel posts with an etch process. Further, this procedure packages FPA units individually, rather than at the wafer level.

An outline of another procedure for fabricating an FPA is included in APPENDIX B. This procedure produces a hollow pixel post.

### Alternative Embodiments

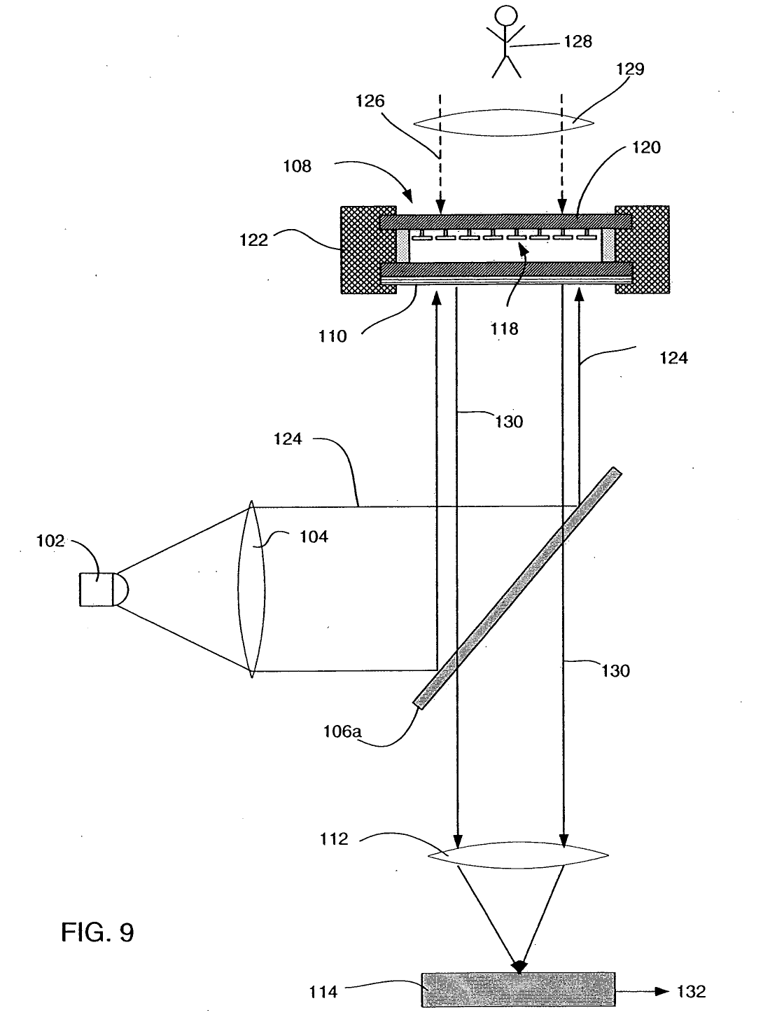

FIG. 9 shows a camera system in which the FPA operates in a reflective mode as compared to the transmissive mode used in the system shown in FIG. 1. In reflective mode, the LED 102 and collimating lens 104 directs collimated NIR light 124 at a splitter 106a, which redirects the NIR light to the FPA 108. The NIR light 124 passes through the reference filter 110 and onto the array of pixel elements 118. The NIR light not transmitted through the array of pixel elements 118 reflects back through the reference filter 110, through the splitter 106a, through the focusing lens 112 and is focused onto the NIR detector array 114. An IR lens 129 focuses the IR energy from the scene to be imaged 128 onto the array of pixel elements 118 through the substrate 120. In the reflective mode, the NIR light 124 does not need to pass through the FPA, so the substrate does not need to be transparent in the NIR wavelength range. The substrate could therefore be made of a material such as silicon that is opaque to NIR light, but is less expensive than sapphire.

The collimating lens 104 in the described embodiment provides uniform illumination for the FPA from an NIR source (LED) that produces a non-uniform transmission pattern. The LED may alternatively use a diffusing lens to smooth out these transmission non-uniformities.

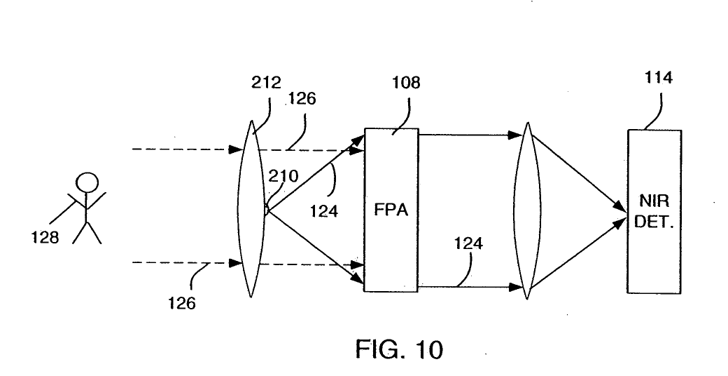

To eliminate the need for reflector 106 in the optical path, the LED for producing NIR light can be incorporated into the IR lens, as shown in FIG. 10. LED 210 is embedded in the center of the IR lens 212, and through appropriate optical engineering, the IR lens 212 is formed in the vicinity of the LED 210 to produce uniform NIR light to illuminate the FPA.

Similarly, an LED 214 can be embedded in the focusing lens 216 for a IR camera system operating in reflective mode, as shown in FIG. 11.

Instead of using a reflector, one could use a grating layer 220 that is applied to the outer surface of the IR window on the FPA 108 to redirect NIR light from an LED set off at an angle, as shown in FIG. 12. One such a grating is a volume phase holographic grating. The line spacing of the holographic grating is selected for a particular angle (with respect to the surface of the FPA) of the NIR light 124, and has little effect on the longer wavelength IR light 126. Alternatively, a fresnel lens could be used as a grating layer 220 to redirect the NIR light 124 and thereby eliminate the reflector 106.

To create a more integrated IR camera system, one can closely associate the FPA with the NIR detector array. This association can be accomplished in at least two different ways. One can fabricate the array of pixel elements 118 directly onto the NIR detector array 114 resulting in a single integrated device. Alternatively, one can fabricate the FPA separate from the NIR detector array, and combine the two components into a single vacuum-sealed package, which would be necessary if the fabrication technologies chosen for the two components are not compatible.

Other Uses of Underlying Principles

The thermal sensor that is the foundation of the IR camera system described herein exhibits high responsivity and is manufacturable with high yield using well-characterized materials and processes. In general, the wavelength of the probe signal is not limited to a particular range, and the wavelength of the signal (if any) that generates thermal changes at the thermally-tunable optical filter derives is not limited to a particular range. Uses of this filter-based thermal sensing system (in addition to the IR camera system described herein) include but are not limited to:

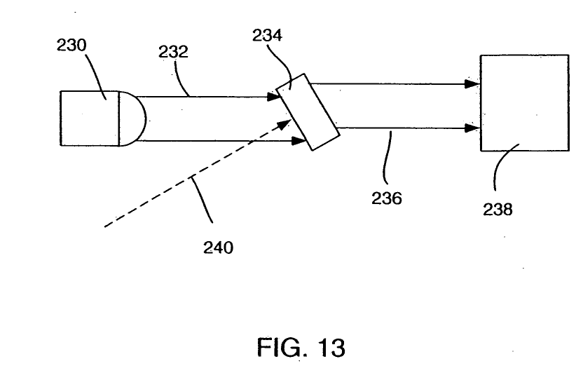

Highly-sensitive, remote readout thermometer. The thermal sensor based on a tunable optical filter can be used to build a very precise thermometer, an example of which is shown in FIG. 13. This thermometer can be optically interrogated either in free space or through an optical fiber. In an optical fiber configuration, multiple sensors can be strung onto a single “bus” or “star” configuration for distributed temperature sensing in a structure or oil/gas well.

FIG. 13 shows the general architecture of the remote readout thermometer. A narrow band NIR source 230 directs a NIR carrier signal 232 through a thermally tunable optical filter 234. The tunable optical filter 234 “modulates” (i.e., filters) the carrier signal 232 according to the temperature of the filter 234, as described herein. IR radiation 240, either from the immediately local environment or from some other source, heats the filter 234. Alternatively, the filter could be heated via mechanisms other than IR radiation (e.g., conduction, convection, etc.). An NIR detector 238 receives the modulated carrier 236, from which it measures the intensity of the modulated carrier 236 corresponding to the temperature of the filter 234. The NIR detector produces an electrical signal, a parameter of which (such as voltage, current, frequency, etc.) corresponds to the temperature of the filter 234.

All of the applications described below for the temperature sensor use essentially the same architecture and functionality as that described in FIG. 13.

Flow sensing and imaging. One or more optical thermal sensors may be used to detect flow rates or flow patterns. One technique for measuring flow rate is to use a heating element to heat a particular point of the flow, and measure the temperature at an upstream point and a downstream point of the flow, both points being equidistant from the heating element. If no material flows, the temperatures at the upstream point and downstream points are equal. As the flow increases, the flowing material carries heat away from the upstream point and toward the downstream point, so that the downstream point has a higher temperature than the upstream point. The flow rate is proportional to the temperature differential between the two points.

Optical thermal sensors may be used to remotely and accurately measure the temperatures at the two points described above. The ability to optically read the temperature of the thermal sensor rather than rely on electrical connections is a valuable feature for measuring remotely located flows, or for measuring corrosive or otherwise dangerous materials. The thermal sensors may take the form of a discrete point, a complete sheet or any other shape necessary for a particular application. Alternatively, the thermal sensors may be used to detect local heating or cooling that results from friction heating, gas compression, or gas decompression. For micro-scale environments this thermal sensing technique measures temperature with very high spatial and thermal resolution and is very useful in emerging micro-fluidic systems used for chemical and biological sensing and discovery. Thermal sensors may be applied on a micro scale directly to the flow surface, without complex patterning steps. Temperature read-out may then be performed remotely and non-invasively.

Accelerometers. Optically-read thermal sensors may be used in thermal accelerometers, which measure acceleration by, for example, monitoring temperature variations about a hermetically sealed bubble of heated air. Acceleration or tilting of the bubble creates flows of the heated air (and thus temperature gradients) in different directions about the bubble, depending upon the direction of the stimulus. Temperature sensors measure the temperature variations due to the flows. A system based on the optical sensors using the architecture and principles described in FIG. 13 could provide several times higher sensitivity to acceleration or tilt. Further, the thermal sensors may be applied on a micro scale directly to surfaces associated with the flows, without complex patterning steps, so that temperature read-out may then be performed remotely and non-invasively.

General radiation sensors. Particular materials are known to absorb various wavelengths of electromagnetic radiation and convert that radiation into thermal energy. These materials may be coupled with the optically-read thermal sensor described above to provide very sensitive electromagnetic detectors using the architecture and principles described in FIG. 13. For instance, X-ray detection and analysis have been demonstrated using sensitive micro-calorimeters. Using this optically read temperature sensor, such a calorimeter may be further thermally isolated (i.e., because of no electrical connections), and the tunable film offers very high responsivity. In this manner the optically-read thermal sensor described above may be used to construct a highly sensitive radiation detector.

Millimeter wave (e.g., THz) and microwave radiation can also be detected with this technique. Some wavelengths require a coupling antenna on the each individual sensor element to transform the incident radiation into heat (i.e., analogous to the IR absorber material in the described embodiment). To avoid obstructing the probe beam, the antennae can be made of conductive oxide that is transparent to the probe beam, or the antennae can use a micro-strip, patch or other low profile design known in the art.

Chemical or biological activity sensors. One or more optically-read thermal sensors, employing the architecture and principles described in FIG. 13, may be used to detect chemical or biological activity that produces or consumes heat. The optical sensor described here has two great advantages for this application. First, the optical sensor may be interrogated remotely using an optical carrier signal, allowing for a simple design for the chemical or biological system, and allowing for much higher levels of thermal insulation for the micro-calorimeters that are used in these systems. Temperature rise due to a reaction in one of these micro-calorimeters is inversely proportional to the conduction path to the substrate, so the elimination of metal electrical contacts significantly enhances sensitivity to temperature changes. Further, remote interrogation allows the sensor to be completely isolated, reducing the possibility of contaminating the chemical or biological activity being measured. Second, the optical sensor is extremely sensitive to temperature changes, so that the sensor can measure very small temperature variations. Together, these advantages provide thermal chemical and biological reaction sensing that is not only many times more sensitive than electronic methods, but also provides a much more simple design, particularly for array structures used in large-scale screening.

This concept can also be used as a contact sensor to analyze surface temperature profiles, for example, those created by fingerprints. A finger contacting a thermal absorber surface on an FPA produces a thermal pattern corresponding to the fingerprint ridge pattern on the absorber. The probe beam is then reflected off of the back of the FPA and detected by a probe detector, so that the image from the probe detector corresponds to the fingerprint ridge pattern. The surface profile of an integrated circuit can be similarly analyzed to detect hot spots indicating fault conditions or regions of high activity.

Other aspects, modifications, and embodiments are within the scope of the claims.

1-42. (canceled)

43. A camera system for producing an image from light of a first wavelength from a scene, comprising:
an array of thermally isolated optical filter pixel elements, wherein each pixel element has an optical passband that shifts in wavelength, due to a refractive index change, as a temperature of the pixel element changes;
optics for directing light of the first wavelength from the scene onto the array of thermally isolated optical filter pixel elements, the thermally isolated optical filter pixel elements converting at least some of the light of the first wavelength into a change in temperature of a thermally isolated optical filter pixel element;
a light source for providing light of a second wavelength to the array of thermally isolated optical filter pixel elements, the light source having a wavelength bandwidth less than the bandpass of the thermally isolated optical filter, the array of thermally-tunable optical pixel elements producing modified light of the second wavelength; and
a detector array for receiving the modified light of the second wavelength and for producing an electrical signal corresponding to an image of the scene, wherein the electrical signal changes as a function of a change in temperature of a thermally isolated optical filter pixel element.

44. The camera system of claim 43, wherein the light of the first wavelength is IR light, and the light of the second wavelength is NIR light.

45. The camera system of claim 43, the array includes a substrate, a matrix of pixel elements each with a thermally isolated optical filter, a thermal path from pixel to the substrate, and a material for absorbing light at the first wavelength and transferring heat from the absorbed light into the thermally isolated optical filter.

46. The camera system on claim 45, wherein the thermal path from pixel element to substrate includes one or more arms connecting the pixel element to substrate.

47. The camera system of claim 43, wherein each pixel element of the array of thermally isolated optical filter pixel elements absorbs light at the first wavelength and converts the light at the first wavelength into heat.

48. The camera system of claim 43, wherein each pixel element of the array of thermally isolated optical filter pixel elements includes an index tunable thin film interference coating.

49. The camera system of claim 38, wherein the index tunable thin film interference coating includes a single-cavity Fabry-Perot structure.

50. The camera system of claim 49, wherein the index tunable thin film interference coating includes a multi-cavity Fabry-Perot structure.

51. The camera system of claim 43, wherein the array of thermally isolated optical filter pixel elements includes a reflecting layer to reflect light of the first wavelength that passes between the pixel elements.

52. The camera system of claim 43, wherein the array of thermally isolated optical filter pixel elements includes an absorbing layer to absorb light of the second wavelength that passes between the pixel elements.

53. The camera system of claim 43, wherein the second wavelength tracks the passband wavelength of the array of thermally isolated optical filter pixel elements.

54. The camera system of claim 43, wherein the light source includes a reference filter for narrowing the bandwidth of the light of the second wavelength.

55. The camera system of claim 43, wherein the light source includes a laser.

56. The camera system of claim 55, wherein the light from the laser tracks the passband wavelength of the array of thermally isolated optical filter pixel elements over changes in camera temperature using feedback.

57. The camera system of claim 54, wherein the reference filter is in thermal contact with the array of thermally isolated optical filter pixel elements so that the temperature of the reference filter tracks the temperature of the array of thermally isolated optical filter pixel elements.

58. The camera system of claim 57, wherein the reference filter and the array of thermally isolated optical filter pixel elements are arranged so as to have little or no temperature difference between them.

59. The camera system of claim 58, wherein the reference filter and the array of thermally isolated optical filter pixel elements are contained within a single temperature-controlled package.

60. The camera system of claim 43, wherein the array of thermally isolated optical filter pixel elements is attached to a substrate, wherein the substrate includes the detector array.

61. The camera system of claim 43, wherein the camera system operates in transmissive mode, such that the light of the second wavelength passes through the array of thermally isolated optical filter pixel elements and then propagates to the detector array.

62. The camera system of claim 43, wherein the camera system operates in a reflective mode, such that the light of the second wavelength reflects off of the array of thermally isolated optical filter pixel elements and then propagates to the detector array.

63. A method of generating a signal based on light of a first wavelength from a scene, comprising:
a thermally isolated optical filter array, wherein each element of the thermally isolated optical filter array has a passband that shifts in wavelength, due to a refractive index change, as a temperature of the thermally isolated optical filter element changes generating light of a second wavelength, the light of the second wavelength having an opitcal bandwidth less than the passband of the thermally isolated optical filter array;
converting the light of the first wavelength to heat, and coupling the heat to the thermally isolated optical filter array;
filtering the light of the second wavelength with the thermally isolated optical filter array such that the thermally isolated optical filter array produces filtered light of the second wavelength; and
detecting the filtered light of the second wavelength with a detector array, so as to produce a signal corresponding to the scene.

64. The method of claim 63, further including operating the array of thermally isolated optical filter pixel elements in a transmissive mode, wherein the light of the second wavelength passes through the array of thermally isolated optical filter pixel elements and propagates to the detector.

65. The method of claim 21 further including operating the array of thermally isolated optical filter pixel elements in a reflective mode, wherein the light of the second wavelength reflects off of the array of thermally isolated optical filter pixel elements and propagates to the detector.

66. The camera system of claim 1, further comprising an optical system between the array of pixel elements and the detector array for focusing light from the array of pixel elements onto the detector array.

67. A camera system for producing an image from light of a first wavelength from a scene, comprising:
an array of thermally isolated optical filter pixel elements, wherein each pixel element has a passband that shifts in wavelength, due to a refractive index change, as a temperature of the pixel element changes;
optics for directing light of the first wavelength from the scene onto the array of thermally isolated optical filter pixel elements, the thermally isolated optical filter pixel elements converting at least some of the light of the first wavelength into a change in temperature of a thermally isolated optical filter pixel element;
a light source for providing light of a second wavelength to the array of thermally isolated optical filter pixel elements, such that the array of thermally-tunable optical pixel elements produces filtered light of the second wavelength;
a filter means for modifying the light of the second wavelength; and
a detector array for receiving the modified light of the second wavelength from the filter means and for producing an electrical signal corresponding to an image of the scene, wherein the electrical signal changes as a function of a change in the light of the first wavelength.
